(19) United States
(12) Patent Application Publication
(10) Pub. No.: US 2002/0165792 A1
(43) Pub. Date: Nov. 7, 2002

(54) Systems and methods for distributing goods, services and benefits according to grouped member matrices

(76) Inventor: Calvin Morrell JR., Irvine, CA (US)

Correspondence Address: Attn: Kurt A. MacLean/Marc Bobys, OPPENHEIMER WOLFF & DONNELLY LLP, Suite 3800, 2029 Century Park East, Los Angeles, CA, 90067, US

(21) Appl. No.: 09/975,666

(22) Filed: Oct. 10, 2001

Related U.S. Application Data
(60) Provisional application No. 60/239,148, filed on Oct. 10, 2000.

(51) Int. Cl. G06F 17/60

(52) U.S. Cl. 705/26

(57) ABSTRACT

Systems and associated methods are disclosed for establishing a new paradigm for a dynamically constructed Web site. The methods are directed to distributing individualized benefits and Web content as dynamically defined by a fluid matrix of variable connections between its elements. The variable connections are identified and established based upon individual multi-variant interests of the members of the collective system. The variable connections within the matrix are variable at will by each of the respective individual members, or the collective on its own, as are the multi-variant interests of each of the individual members. This fluidity enables the systems of the present invention to define and redefine themselves by virtue of their participatory members interests.

### RELATED APPLICATIONS

This Application claims priority of U.S. Provisional Application No. 60/239,148 filed Oct. 10, 2000, incorporated herein by reference.

### BACKGROUND OF THE INVENTION

1. Field of the Invention

This invention relates to the World Wide Web and to targeted distribution of content thereon. More particularly, the invention relates to purchasing power collectives and to methods for distributing content and accessing members according to construed and applied variable connections between the members which create identifiable groups within a variable matrix.

2. General Background and State of the Art

The Internet provides a new medium in which to view, appreciate and utilize various forms of entertainment, information, shopping, and a variety of other interactive services to millions of members around the world. One way to access this large pool of members is by specific targeting through identifiable member traits. Therefore, much attention has been focused on identifying and targeting large groups of members on the Internet.

A popular method for identifying large, targetable Internet member groups is the application of a registration process. By providing a Web site to which Internet members can subscribe, or become members of, a registration process can be implemented for the purpose of gleaning information from each registering member. Such a registration process can be customized to best suit the targeting needs of the Web site provider. For example, a Web site dedicated to animals may include a registration process wherein registering members are queried as to the kinds of pets they own. Once this information is gathered, the registered members can be targeted in groups according to their pet type. An advertisement for dog food can be focused and targeted to only those members who indicated ownership of a dog during registration, while a sale on catnip can be targeted to the identified cat owners.

Another prior art approach to customization according to member trait identification is the development of collective membership buyer's clubs. In these systems, members may form groups, at will, expressly for the purpose of purchasing items in quantity. By identifying a common product that each of a group of members intends to purchase, the group can combine their collective purchasing power to negotiate a lower price for the good.

Unfortunately, these registration-based and collective buyer systems have a number of drawbacks. There is no guarantee that a registering member will provide legitimate information during the registration process. After a member is registered, there are limited means through which to gather additional or updated information Also, the mere existence of the Web site, or the collective purchasing group, is predicated upon an initial purpose, or theme, which acts to limit the applications thereof.

What is needed is a novel structural Web site that can reliably, accurately, and consistently identify varying groups of Internet members over time with the ability to distinguish and identify the groups for different purposes at any given time such that the benefits are flexible and are not limited to a theme of a particular Web site at its inception.

### INVENTION SUMMARY

These and other objectives are achieved by the present invention which, in a broad aspect, provides variable matrix, combined purchasing power collective systems and associated methods of use in which a large volume of Internet members may be effectively identified, characterized, and grouped over time. The grouping is arranged according to any number of criteria for the purpose of tailoring content to any specific group or subgroup thereof, in addition to leveraging group purchasing power benefits which may be distributed to all or to part of the group or subgroups depending upon individual member preferences. This dynamically variable, yet relatively stable, large member base is described by a matrix of variable connections between members based upon individual multi-variant interests. The member base is established and sustained through customized attention, wherein the content of the Web is automatically filtered and provided to identified appropriate variable sub-groups within the collective matrix system of the member base. The identification and grouping of the members is conducted through characterizing each member's activities on the Internet to identify individual multi-variant interests within the collective matrix. These activities can occur and be tracked through a communicating linkage, such as a computer network link, between the member and the collective. These groups are tracked relative to their activities in response to various benefit distributions within the collective, which benefits are acquired from outside providers of goods and services. Such benefits may be transmitted to the members of a group through a communicating linkage from the collective to the benefits provider, such as an Internet or other computer network communication link.

The foregoing and other objects, features, and advantages of the present invention will be become apparent from a reading of the following detailed description of exemplary embodiments thereof, which illustrate the features and advantages of the invention in conjunction with references to the accompanying drawing Figures.

### BRIEF DESCRIPTION OF THE DRAWINGS

FIG. 1 illustrates an exemplary matrix system of the present invention over sequential moments in time, I, II, III, and exemplifies the fluidly variable interconnections thereof; and

FIG. 2 illustrates an exemplary system of the present invention which implements a method of the present invention, directed to utilization of the variable matrix, combined purchasing power collective system of the present invention.

### DETAILED DESCRIPTION OF EXEMPLARY EMBODIMENTS

In the following description of exemplary embodiments of the present invention, reference is made to the accompanying drawings which form a part thereof, and in which are shown by way of illustration specific embodiments illustrative of the manner in which the present invention may be practiced. It is to be understood that other embodiments may be utilized and that structural and functional changes may be made without departing from the scope of the present invention.

The present invention provides a new foundational paradigm for Web sites. In contrast to prior art systems, which service a particular need and hope to find a market for it, the variable matrix, combined purchasing power collective system of the present invention creates a place for members to visit, such that any of a plurality of their needs can be identified and addressed at any time. In this way, the system of the present invention is able to define itself and to modify itself over time in response to varying inputs from the users as well as the providers.

Unlike existing buyer's clubs which distribute benefits equally throughout a collective membership, the present invention distributes individualized benefits as predefined and as continually modified by a fluid matrix of variable connections between the members of the collective system based upon the individual interests of the members and subgroups thereof. For purposes of clarity, as used herein, the term “fluid” indicates the variable nature of connections between elements of the matrix of the present invention.

In an illustrative embodiment of the present invention, a Web site is provided to all members of the Internet. This Web site may be a portal or other model for accessing information on the Internet. The content of the Web site, including its offerings and appearance, is dynamic in nature. That is, the content of the Web site can be customized to each individual member, or to groups of members, and manifests itself accordingly. Web site customization directed to a group of members is accomplished by identifying traits or multi-variant interests among individual members over time and using those multi-variant interests to organize the members into groups.

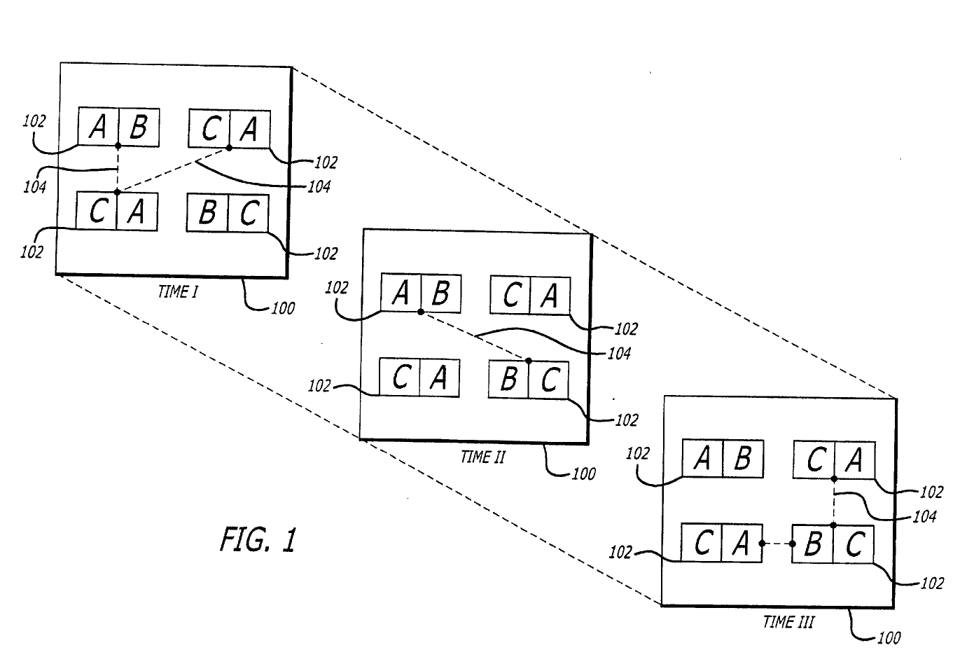

FIG. 1 illustrates an exemplary, variable matrix combined purchasing power collective system 100 of the present invention comprising, as its exemplary elements, a total of four members 102 that can be organized in any of three groups according to the fluid, variable connections 104 of the variable matrix of the present invention. Each member 102 has identifiable traits or multi-variant interests that are used to establish varying matrix connections. In this illustration, each member 102 has two identifiable multi-variant interests, denoted in FIG. 1 by lettered idicia: A, B, C or D. In FIG. 1, at time I, a group of three members 102 is identified wherein each member 102 of the group has the similar multi-variant interest “A.” At time II, a group of three members 102 is identified wherein each member 102 of the group has the similar multi-variant interest “B.” At time III, a group of two members 102 is identified wherein each member 102 of the group has the similar multi-variant interest “C.” It is contemplated as being within the scope of the present invention that respective individual members 102 will not be defined by only one or two multi-variant interests, but can be defined by a virtually unlimited number of multi-variant interests. It should be noted as well that the variable matrices which manifest through applications of the present invention can be much larger and can have much more intricate variable connections between their groups, subgroups, and individual elements.

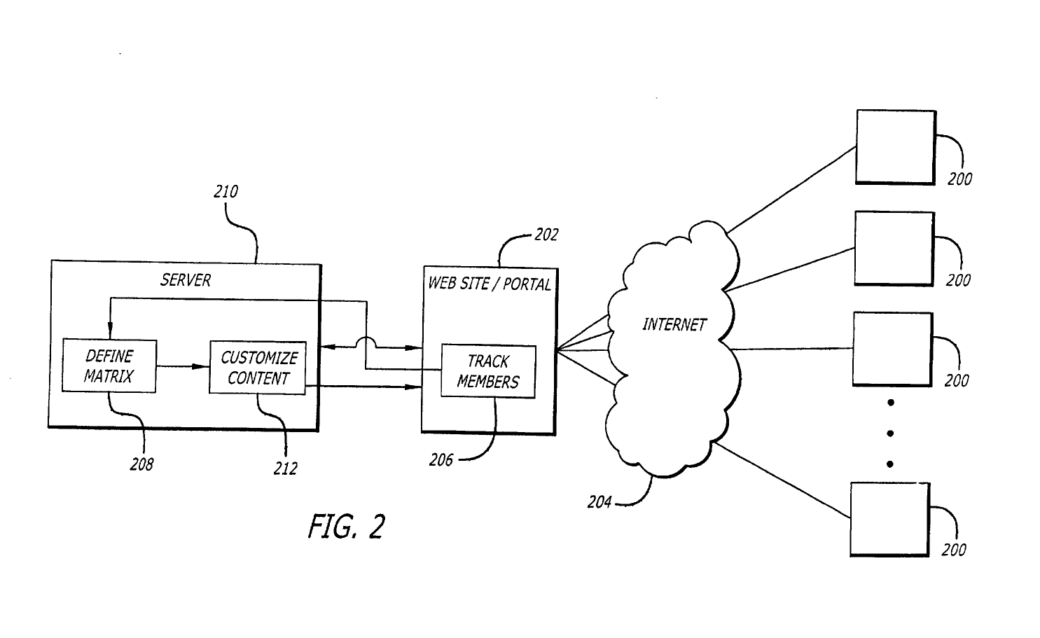

FIG. 2 illustrates an additional exemplary embodiment for a system utilizing the variable matrix of the present invention. This exemplary system operates according to an exemplary method of the present invention, directed at utilization of the variable matrix. In this system, a plurality of members 200 access Web site 202 through an Internet connection 204. Web site 202 may be a portal or other means of general access to Internet content. However, in accordance with the teachings of the present invention, Web site 202 is not designed for a specified, static purpose. In contrast to prior art sites, the design, appearance and content of Web site 202 change with time and history, and are construed for particular members or groups of members, as previously discussed. For this reason, Web site 202 may have a different appearance to different members, though visited by those members at the same point in time.

As illustrated in FIG. 2, a function performed by software 206 on Web site 202 is tracking of individual members' activities on the Web site. Such tracking may be accomplished by a variety of methods that are well-known in the art. In accordance with the teachings of the present invention, this tracking is performed for the purpose of collecting information with which to characterize members and to identify and establish multi-variant interests among and between those members through which to group the members by forming connections within the variable matrix, combined purchasing power collective system. Matrices and their fluid connections are calculated by software-based algorithms 208 that may be stored and executed on server system 210 which supports Web page 202 of the variable matrix collective system. According to the defined connections and groups within the matrix, then, customization algorithms 212 operative on server 210 can customize the content, delivery, appearance and other characteristics of Web page 202 for each of a plurality of different groups or subgroups within the variable matrix of the combined purchasing power collective system of the present invention.

It will be recognized by those skilled in the art that a virtually unlimited number of software-based algorithms 208 may be defined and developed for calculating the connections for defining matrices within various embodiments of the present invention. For illustrative purposes, an example is now described, however it is to be understood that the example is not to be read in a limiting sense. In an exemplary embodiment, of the present invention, Web page 202 may be manifested, within a sub-group of users or within a particular matrix, as a gaming Web site. Such a matrix, then, is defined in accordance with the teachings of the present invention by connections associated with the multi-variant interest defined as network computer gaming.

In this exemplary computer gaming embodiment, individual members having the network computer gaming multi-variant interest associated with themselves will become part of the matrix, as defined by connections based upon the computer gaming multi-variant interest, and when calling Web site 202 will retrieve and view it as a gaming Web site. Within exemplary Web site 202 are various interactive features such as questions, polls, contests, games, product purchase opportunities, and the like. The linked individual users of this matrix, when visiting the exemplary gaming Web site, will transmit certain information through these interactive features. This information may be part of the user's response to a particular question, or may be a form of demographic data gleaned from characteristics of the user's purchase of some particular product, for example. Further, the information may be calculated and construed as a function of multi-variant interests already assigned to the respective, linked individual users taken in combination with new information provided by each individual user through the exemplary gaming Web site. According to this function, whether obtained directly from the individual user or calculated as a function of multiple pieces of other user data, the information is then used to associate the individual user or users with a new multi-variant interest or interests. This newly associated multi-variant interest may be a pre-defined multi-variant interest that was already existent within the exemplary embodiment of the present invention, or may be a newly defined multi-variant interest that is calculated and defined specifically in response to the individual user's information. In any case, the newly associated multi-variant interest causes the individual user to be re-assigned to a new or additional matrix.

This is one example that illustrates the fluid and dynamic nature of the matrices of the present invention, according to the interconnections that are defined by multi-variant interests associated with individual users. As the individual user becomes associated with new or changing matrices, Web site 202 may manifest itself with a different appearance to that individual user. For example, It may be that the individual user still interacts with the gaming Web site that now has different contests or offers the sale of products customized to this member's newly-associated multi-variant interest, or, alternatively, it may be that Web site 202 manifests itself as a completely different interactive environment to this individual user. Of course, the manifesting of Web site 202 should be handled by embodiments of the present invention such that the needs of the individual members are addressed. That is, Web site 202, in embodiments of the present invention, are dynamic in their response to changing multi-variant interests of the individual members.

The customization of the Web sites of the present invention is dynamic, in that the Web page has no standard form or content, and is essentially “built” real time according to the defined needs of the individual members or groups of members. Because of this, the present invention provides the unique ability for members to define their needs as they desire, merely by their routine activities on the Internet. Alternatively, it is within the scope of the present invention to actively pre-define the form and content of the Web site and then modify it in response to the multi-variant interests of the members as well as the benefits provided by the outside providers of goods and services.

The foregoing descriptions of exemplary embodiments of the present invention have been presented for the purposes of illustration, description and enablement. They are not intended to be exhaustive or to limit the present invention to the precise forms illustrated. Many modifications and variations of the present invention are possible within the scope of the above teachings. For example, an actual Web page need not be presented to members. In this case, members would have content directed to them through advertisements or other means.

It is intended that the scope of the present invention be limited not by this detailed description, but only by the claims appended hereto.

What is claimed is:

1. A variable matrix, combined purchasing power, actively interconnected, member collective system comprising:
a plurality of individual members, each of said members having at least one, multi-variant interest;
a matrix of variable connections between respective ones of said plurality of individual members and defining at least one lesser plurality of individual members within said plurality of individual members, each of said variable connections based upon respective ones of said at least one, multi-variant interest; and
at least one communicating linkage from said combined purchasing power, actively interconnected, member collective system to a provider of benefits.

2. The variable matrix, combined purchasing power, actively interconnected, member collective system of claim 1, wherein said at least one communicating linkage comprises an Internet connection.

3. The variable matrix, combined purchasing power, actively interconnected, member collective system of claim 1, wherein said at least one communicating link is a first communicating link; and further comprising:
a second communicating linkage between at least one of said plurality of said individual members and said combined purchasing power, actively interconnected, member collective system.

4. The variable matrix, combined purchasing power, actively interconnected, member collective system of claim 3, wherein said first communication linkage and said second communication linkage each comprise an Internet connection.

5. The variable matrix, combined purchasing power, actively interconnected, member collective system of claim 1, wherein said multi-variant interest is related to a benefit available for purchase by said individual members.

6. The variable matrix, combined purchasing power, actively interconnected, member collective system of claim 5, wherein said benefit comprises a discount on purchasing.

7. The variable matrix, combined purchasing power, actively interconnected, member collective system of claim 5, wherein said benefit comprises a credit applicable toward purchase.

8. A method for distributing benefits according to grouped member matrices of a combined purchasing power collective system, said method comprising the steps of:
providing an actively interconnected member collective system of a plurality of individual members, each of said members having at least one multi-variant interest;
defining at least one lesser plurality of individual members having at least one common multi-variant interest within said plurality of individual members;
forming a matrix of variable connections between respective members of said at least one lesser plurality of individual members;
utilizing the combined purchasing power of said actively interconnected collective system to leverage at least one benefit from a provider; and
distributing said at least one benefit throughout said actively interconnected collective system to individual members of said at least one lesser plurality of individual members based upon said at least one common multi-variant interest.

9. The method for distributing benefits according to grouped member matrices of a combined purchasing power collective system of claim 8, further comprising receiving a response from said individual members to said distributing of said benefit.

10. The method for distributing benefits according to grouped member matrices of a combined purchasing power collective system of claim 9, wherein said multi-variant interest is identified through a tracking process wherein said response from said individual member is associated with said multi-variant interest.

11. The method for distributing benefits according to grouped member matrices of a combined purchasing power collective system of claim 9, wherein said multi-variant interest is defined and associated with said individual member through a tracking process wherein said response from said individual member is recorded and used to define said multi-variant interest.

12. The method for distributing benefits according to grouped member matrices of a combined purchasing power collective system of claim 10, wherein said multi-variant interest is associated with a product or service available for purchase by said individual members.

13. The method for distributing benefits according to grouped member matrices of a combined purchasing power collective system of claim 12, wherein:
said benefit is associated with said product or service; and
said distributing of said benefit occurs through an Internet connection.

14. The method for distributing benefits according to grouped member matrices of a combined purchasing power collective system of claim 13, wherein said benefit comprises a discount on purchasing.

15. The method for distributing benefits according to grouped member matrices of a combined purchasing power collective system of claim 13, wherein said benefit comprises a credit applicable toward purchase.

16. The method for distributing benefits according to grouped member matrices of a combined purchasing power collective system of claim 13, wherein said distributing of said benefit comprises assembling a customized Web site for said individual member according to said multi-variant interest.
